(19) United States
(12) Patent Application Publication
(10) Pub. No.: US 2010/0211656 A1
(43) Pub. Date: Aug. 19, 2010

(54) Configuring A Blade Environment

(75) Inventors: William G. Pagan, DURHAM, NC (US); Marc V. Stracuzza, DURHAM, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/372,266

(22) Filed: Feb. 17, 2009

(51) Int. Cl. G06F 15/177

(52) U.S. Cl. 709/220

(57) ABSTRACT

Configuring a blade environment, the blade environment including a chassis, a plurality of blade servers, and a management module, including receiving prior to delivery of the blade environment, from an end-user of the blade environment by a configuration module accessible through a wide-area network, configuration information for the blade environment; wherein the configuration information is specific to the end-user; storing, by the configuration module, the configuration information in a configuration file; after delivery of the blade environment to the end-user; downloading, from the configuration module to the management module on the blade environment, the configuration file; and configuring, by the management module, the blade environment using the configuration information stored in the configuration file.

### BACKGROUND OF THE INVENTION

1. Field of the Invention

The field of the invention is data processing, or, more specifically, methods, apparatus, and products for configuring a blade environment.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Some computing systems today are configured as blade environments having blade servers with relatively small form factors installed in blade server chassis.

Configuring these blade environments can be difficult and inefficient.

### SUMMARY OF THE INVENTION

Configuring a blade environment, the blade environment including a chassis, a plurality of blade servers, and a management module, including receiving prior to delivery of the blade environment, from an end-user of the blade environment by a configuration module accessible through a wide-area network, configuration information for the blade environment; wherein the configuration information is specific to the end-user; storing, by the configuration module, the configuration information in a configuration file; after delivery of the blade environment to the end-user; downloading, from the configuration module to the management module on the blade environment, the configuration file; and configuring, by the management module, the blade environment using the configuration information stored in the configuration file.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary blade environment configured according to embodiments of the present invention.

FIG. 2 sets forth a flow chart illustrating an exemplary method for configuring a blade environment according to embodiments of the present invention.

FIG. 3 sets forth a flow chart illustrating another exemplary method for configuring a blade environment according to embodiments of the present invention.

### DETAILED DESCRIPTION OF EXEMPLARY EMBODIMENTS

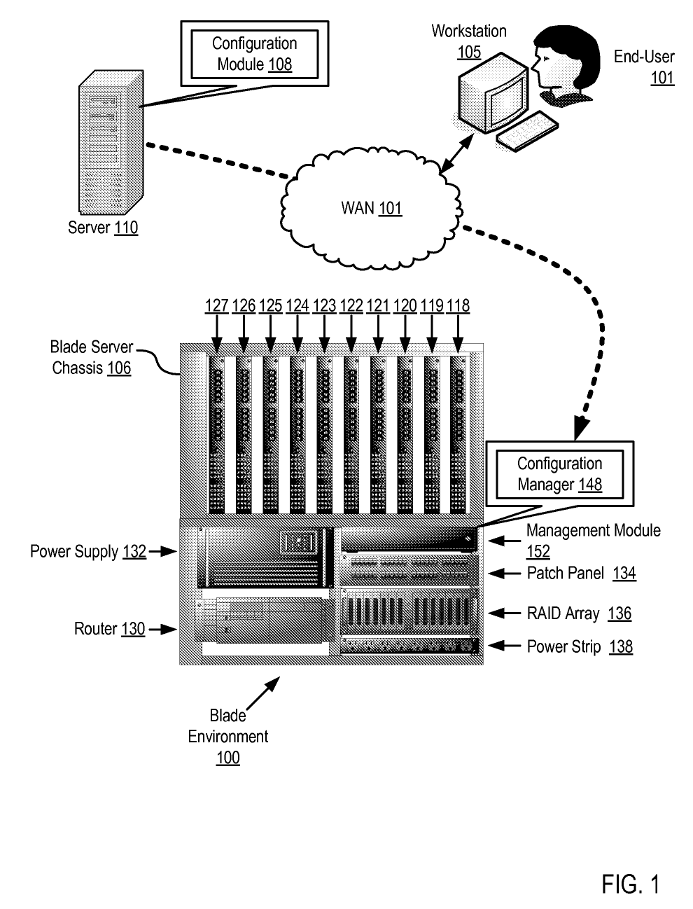

Exemplary methods, apparatus, and products for configuring a blade environment in accordance with the present invention are described with reference to the accompanying drawings, beginning with FIG. 1. FIG. 1 sets forth a functional block diagram of an exemplary blade environment (100) configured according to embodiments of the present invention. Blade environments capable of being configured according to embodiments of the present invention include the Blade System from HP, the BladeCenter from IBM®, and others as will occur to those of skill in the art.

The blade environment (100) in the example of FIG. 1 includes a blade server chassis (106) housing a number of blade servers (118-127). Blade servers (118-127) are installed in blade server chassis (106). A blade server chassis is an enclosure in which blade servers as well as other electrical components are installed. The chassis provides cooling for servers, data communications networking connections, input/output device connections, power connections, and so on as will occur to those of skill in the art. One example blade server chassis is IBM's BladeCenter. An IBM BladeCenter E includes 14 blade slots, a shared media tray with an optical drive, floppy drive, and Universal Serial Bus (‘USB’) port, one or more management modules, two or more power supplies, two redundant high speed blowers, two slots for Gigabit Ethernet switches, and two slots for optional switch or pass-through modules such as Ethernet, Fibre Channel, InfiniBand or Myrient 2000 modules.

A server, as the term is used in this specification, refers generally to a multi-user computer that provides a service (e.g. database access, file transfer, remote access) or resources (e.g. file space) over a network connection. The term ‘server,’ as context requires, refers inclusively to the server's computer hardware as well as any server application software or operating system software running on the server. A server application is an application program that accepts connections in order to service requests from users by sending back responses. A server application can run on the same computer as the client application using it, or a server application can accept connections through a computer network. Examples of server applications include file server, database server, backup server, print server, mail server, web server, FTP servers, application servers, VPN servers, DHCP servers, DNS servers, WINS servers, logon servers, security servers, domain controllers, backup domain controllers, proxy servers, firewalls, and so on.

Blade servers are self-contained servers, designed for high density. As a practical matter, all computers are implemented with electrical components requiring power that produces heat. Components such as processors, memory, hard drives, power supplies, storage and network connections, keyboards, video components, a mouse, and so on, merely support the basic computing function, yet they all add bulk, heat, complexity, and moving parts that are more prone to failure than solid-state components. In the blade paradigm, most of these functions are removed from the blade computer, being either provided by the blade server chassis (DC power) virtualized (iSCSI storage, remote console over IP), or discarded entirely (serial ports). The blade itself becomes simpler, smaller, and amenable to dense installation with many blade servers in a single blade server chassis.

In addition to the blade servers (109-127), the blade server chassis (104, 106) in the example of FIG. 1 also house several other electrical components including a power supply (132), a data communications router (130), a patch panel (134) a RAID array (136), a power strip (138) and a management module (152).

A management module is an aggregation of computer hardware and software that is installed in a data center to provide support services for computing devices, such as blade servers. Support services provided by the management module (152) include monitoring health of computing devices and reporting health statistics to a system management server, power management and power control, save and restore configurations, discovery of available computing devices, event log management, memory management, and so on. An example of a management module that can be adapted for use in systems for securing blade servers according to embodiments of the present invention is IBM's Advanced Management Module (‘AMM’). The management module of FIG. 1 includes a configuration manager (148), computer program instructions useful in configuring blade environments according to the present invention.

In the example of FIG. 1, aspects of the blade environment (100) may be preconfigured after purchase of the blade environment but prior to its delivery. In the example of FIG. 1 configuring the blade environment (100) is carried out by receiving prior to delivery of the blade environment (100), from an end-user (101) of the blade environment (100) by a configuration module (108) accessible through a wide-area network (108), configuration information for the blade environment. In the example of FIG. 1, an end-user (101) is provided a user account with the configuration module (108) and logs into the user account using a workstation (105). The end-user provides configuration information that is specific to that end-user's use of the blade environment. Examples of configuration information specific to the end-user include user network configuration information, blade boot order, alert policies for thermal events, user account information, security information, and so on.

In the example of FIG. 1 the configuration module (108) stores the configuration information in a configuration file. The configuration file may be implemented as a text file including the configuration information, an XML file, or any other file that may usefully store the configuration information that will occur to those of skill in the art.

Typical management modules of blade environments permit configuration by an end-user through a web interface after delivery of the blade environment. That is, a user can point a web browser at the management module and be presented with configuration screens for configuring the blade environment, obtaining telemetry from the blades, and so on. In the example of FIG. 1, the configuration module available to the end-user across the WAN and before delivery of the blade environment may be designed to simulate the configuration practices of the management module itself As such, the configuration module may simulate the presence of blades and other components of the blade environment to be configured according to embodiments of the present invention.

After delivery of the blade environment (100) to the end-user, the example of FIG. 1 includes downloading, from the configuration module (108) to the management module (152) on the blade environment, the configuration file and configuring, by the management module (152), the blade environment using the configuration information stored in the configuration file. The management module (152) of FIG. 1 includes a configuration manager (148), computer instructions capable of initiating a download, from the configuration module (108) across a wide area network (101) to the management module (148) on the blade environment, the configuration file and configuring the blade environment using the configuration information stored in the configuration file.

In some alternate embodiments, the management module does not have access to a wide area network or external network. In such, embodiments, downloading, from the configuration module to the management module on the blade environment, the configuration file is carried out by downloading the configuration file to a storage medium and transferring the configuration file from the storage medium to the management module.

The arrangement of servers, chassis, routers, power supplies, management modules, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

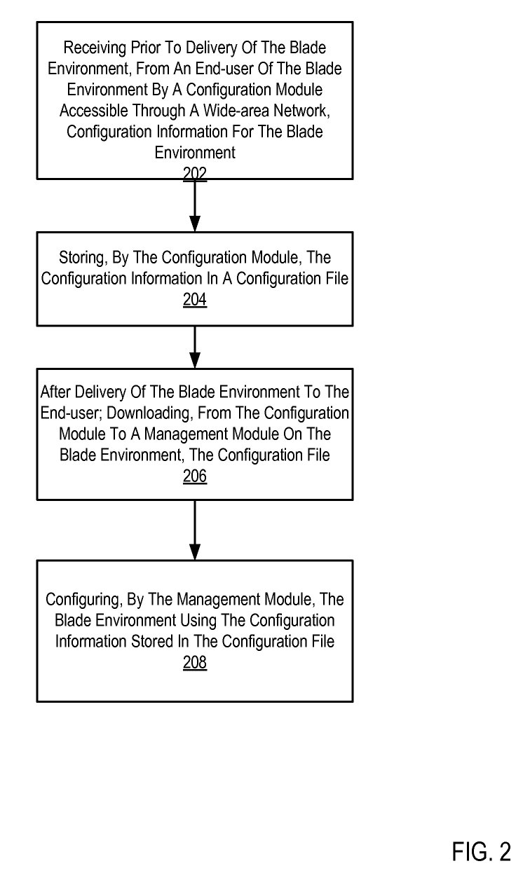

For further explanation, FIG. 2 sets forth a flow chart illustrating an exemplary method for configuring a blade environment according to embodiments of the present invention. The blade environment includes at least a chassis, a plurality of blade servers, and a management module. The method of FIG. 2 includes receiving (202) prior to delivery of the blade environment, from an end-user of the blade environment by a configuration module accessible through a wide-area network, configuration information for the blade environment. Receiving (202) the configuration information prior to delivery of the blade environment provides efficient configuration of the blade environment after its delivery to the end user.

In the example of FIG. 2, the configuration information is specific to the end-user. Examples of configuration information specific to the end-user include user network configuration information, blade boot order, alert policies for thermal events, user account information, security information, and so on.

The method of FIG. 2 also includes storing (204), by the configuration module, the configuration information in a configuration file. A configuration file may be implemented as a text file including the configuration information, an XML file, or any other file that may usefully store the configuration information that will occur to those of skill in the art.

After delivery of the blade environment to the end-user, the method of FIG. 2 includes downloading (206), from the configuration module to a management module on the blade environment, the configuration file. Downloading the configuration file and configuring the blade environment may be initiated by a blade environment distributor, by the end-user, or by any other system or person.

In some alternate embodiments, the management module does not have access to a wide area network or external network. In such, embodiments, downloading, from the configuration module to the management module on the blade environment, the configuration file is carried out by downloading the configuration file to a storage medium and transferring the configuration file from the storage medium to the management module. Downloading the configuration file to a storage medium and transferring the configuration file from the storage medium to the management module may be carried out manually by the end-user.

The method of FIG. 2 includes configuring (208), by the management module, the blade environment using the configuration information stored in the configuration file. Configuring (208) the blade environment using the configuration information stored in the configuration file may be carried out by establishing the configuration information as initial user-specific system values for hardware and software of the blade environment. Configuring (208) the blade environment may include network configuration, configuring blade boot order of the blades on the blade environment, configuring alert policies for thermal events, configuring user accounts with the blade environment, configuring security settings for the blade environment, and so on.

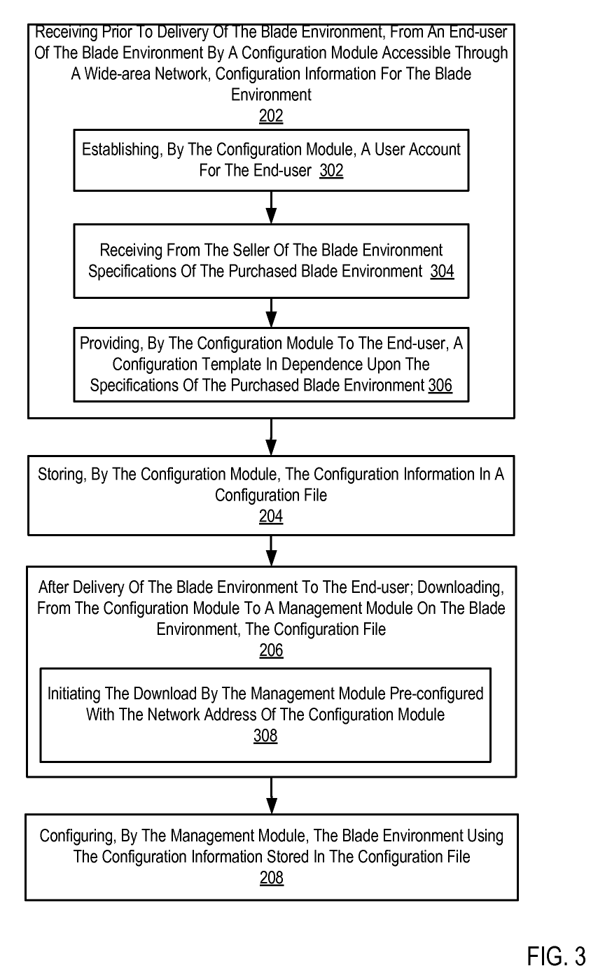

For further explanation, FIG. 3 sets forth a flow chart illustrating another exemplary method for configuring a blade environment according to embodiments of the present invention. The method of FIG. 3 is similar to the method of FIG. 2 in that the method of FIG. 3 includes receiving (202) prior to delivery of the blade environment, from an end-user of the blade environment by a configuration module accessible through a wide-area network, configuration information for the blade environment; storing (204), by the configuration module, the configuration information in a configuration file; after delivery of the blade environment to the end-user, downloading (206), from the configuration module to a management module on the blade environment, the configuration file and configuring (208), by the management module, the blade environment using the configuration information stored in the configuration file.

The method of FIG. 3 differs from the method of FIG. 2 in that in the method of FIG. 3, receiving (202) prior to delivery of the blade environment configuration information for the blade environment includes establishing (302), by the configuration module, a user account for the end-user. Establishing (302) a user account for the end-user allows the user to log into the configuration module and provide configuration information for the blade environment prior to its delivery. Establishing (302) a user account for the end-user also allows a user to edit such configuration information at any time—even after delivery of the blade environment—for download to the management module and configuration. User accounts usefully allow a user to manage configuration of the blade environment from its purchase prior to its delivery and also allows continued management of the configuration of the blade environment after its delivery.

In the method of FIG. 3, receiving (202) prior to delivery of the blade environment configuration information for the blade environment also includes receiving (304) from the seller of the blade environment specifications of the purchased blade environment. Upon completion of the sale of the blade environment many hardware and software specifications of the purchased blade environment are known. Such specifications may be provided to the configuration module without requiring the end-user to include those known specifications in the user-specific configuration information. Examples of such specifications include the number of blades housed in the chassis, the types of servers running on the blades, the specifications of the blade server chassis, software provided with the sale and so on as will occur to those of skill in the art.

In the method of FIG. 3, receiving (202) prior to delivery of the blade environment configuration information for the blade environment includes providing (306), by the configuration module to the end-user, a configuration template in dependence upon the specifications of the purchased blade environment. A configuration template provided in dependence upon the specifications of the purchased blade environment allows a user to be prompted for the user-specific configuration information needed to configure the blade environment after its delivery. Providing, by the new module to the end-user, a configuration template in dependence upon the specifications of the purchased blade environment may include dynamically generating the template in dependence upon the specifications of the purchased blade environment. Providing, by the configuration module to the end-user, a configuration template in dependence upon the specifications of the purchased blade environment may also include retrieving from a database a pre-created template in dependence upon the specifications of the purchased blade environment.

In the method of FIG. 3, downloading (308), from the configuration module to a management module on the blade environment, the configuration file includes initiating (308) the download by the management module pre-configured with the network address of the configuration module. Initiating (308) the download by the management module pre-configured with the network address of the configuration module allows the configuration of the blade environment to begin automatically after delivery of the blade environment without user intervention.

Exemplary embodiments of the present invention are described largely in the context of a fully functional computer system for configuring a blade environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of configuring a blade environment, the blade environment including a chassis, a plurality of blade servers, and a management module, the method comprising:
receiving prior to delivery of the blade environment, from an end-user of the blade environment by a configuration module accessible through a wide-area network, configuration information for the blade environment;
wherein the configuration information is specific to the end-user;
storing, by the configuration module, the configuration information in a configuration file;
after delivery of the blade environment to the end-user; downloading, from the configuration module to the management module on the blade environment, the configuration file; and
configuring, by the management module, the blade environment using the configuration information stored in the configuration file.

2. The method of claim 1 wherein receiving prior to delivery of the blade environment configuration information for the blade environment further comprises establishing, by the configuration module, a user account for the end-user.

3. The method of claim 1 wherein downloading, from the configuration module to a management module on the blade environment, the configuration file further comprises initiating the download by the management module pre-configured with the network address of the configuration module.

4. The method of claim 1 wherein receiving prior to delivery of the blade environment configuration information for the blade environment further comprises receiving from the seller of the blade environment specifications of the purchased blade environment.

5. The method of claim 1 wherein receiving prior to delivery of the blade environment configuration information for the blade environment further comprises providing, by the configuration module to the end-user, a configuration template in dependence upon specifications of the purchased blade environment.

6. The method of claim 1 wherein the configuration information for the blade environment includes network configuration information, blade boot order, and alert policies.

7. An apparatus for configuring a blade environment, the blade environment including a chassis, a plurality of blade servers, and a management module, the management module having computer memory having disposed within it computer program instructions capable of:
receiving prior to delivery of the blade environment, from an end-user of the blade environment by a configuration module accessible through a wide-area network, configuration information for the blade environment;
wherein the configuration information is specific to the end-user;
storing, by the configuration module, the configuration information in a configuration file;
after delivery of the blade environment to the end-user; downloading, from the configuration module to the management module on the blade environment, the configuration file; and
configuring, by the management module, the blade environment using the configuration information stored in the configuration file.

8. The apparatus of claim 7 wherein computer program instructions capable of receiving prior to delivery of the blade environment configuration information for the blade environment further comprise computer program instructions capable of establishing, by the configuration module, a user account for the end-user.

9. The apparatus of claim 7 wherein computer program instructions capable of downloading, from the configuration module to a management module on the blade environment, the configuration file further comprise computer program instructions capable of initiating the download by the management module pre-configured with the network address of the configuration module.

10. The apparatus of claim 7 wherein computer program instructions capable of receiving prior to delivery of the blade environment configuration information for the blade environment further comprise computer program instructions capable of receiving from the seller of the blade environment specifications of the purchased blade environment.

11. The apparatus of claim 7 wherein computer program instructions capable of receiving prior to delivery of the blade environment configuration information for the blade environment further comprise computer program instructions capable of providing, by the configuration module to the end-user, a configuration template in dependence upon specifications of the purchased blade environment.

12. The apparatus of claim 7 wherein the configuration information for the blade environment includes network configuration information, blade boot order, and alert policies.

13. A computer program product for configuring a blade environment, the computer program product disposed in a computer readable recording medium, the computer program product comprising computer program instructions capable of:
receiving prior to delivery of the blade environment, from an end-user of the blade environment by a configuration module accessible through a wide-area network, configuration information for the blade environment;
wherein the configuration information is specific to the end-user;
storing, by the configuration module, the configuration information in a configuration file;
after delivery of the blade environment to the end-user; downloading, from the configuration module to the management module on the blade environment, the configuration file; and
configuring, by the management module, the blade environment using the configuration information stored in the configuration file.

14. The computer program product of claim 13 wherein computer program instructions capable of receiving prior to delivery of the blade environment configuration information for the blade environment further comprise computer program instructions capable of establishing, by the configuration module, a user account for the end-user.

15. The computer program product of claim 13 wherein computer program instructions capable of downloading, from the configuration module to a management module on the blade environment, the configuration file further comprise computer program instructions capable of initiating the download by the management module pre-configured with the network address of the configuration module.

16. The computer program product of claim 13 wherein computer program instructions capable of receiving prior to delivery of the blade environment configuration information for the blade environment further comprise computer program instructions capable of receiving from the seller of the blade environment specifications of the purchased blade environment.

17. The computer program product of claim 13 wherein computer program instructions capable of receiving prior to delivery of the blade environment configuration information for the blade environment further comprise computer program instructions capable of providing, by the configuration module to the end-user, a configuration template in dependence upon specifications of the purchased blade environment.

18. The computer program product of claim 13 wherein the configuration information for the blade environment includes network configuration information, blade boot order, and alert policies.
